(19) United States
(12) Patent Application Publication
(10) Pub. No.: US 2024/0152753 A1
(43) Pub. Date: May 9, 2024

(54) METHOD AND APPARATUS WITH TRAINING OF BATCH NORM PARAMETER

(71) Applicants: SAMSUNG ELECTRONICS CO., LTD., Suwon-si (KR); IUCF-HYU(Industry-University Cooperation Foundation Hanyang University), Seoul (KR)

(72) Inventors: Jungwook CHOI, Suwon-si (KR); Seongmin PARK, Seoul (KR)

(73) Assignees: SAMSUNG ELECTRONICS CO., LTD., Suwon-si (KR); IUCF-HYU(Industry-University Cooperation Foundation Hanyang University), Seoul (KR)

(21) Appl. No.: 18/384,463

(22) Filed: Oct. 27, 2023

(30) Foreign Application Priority Data
Nov. 7, 2022 (KR) 10-2022-0147117

(51) Int. Cl. G06N 3/08

(52) U.S. Cl. CPC G06N 3/08

(57) ABSTRACT

Disclosed is a processor implemented method that includes calculating a quantization error for each channel of a neural network using activation data output from a first layer of the neural network and a quantization scale of a second layer connected to the first layer, calculating a final loss using a regularization loss term determined based on the quantization error for each channel, and updating a batch norm parameter of the first layer in a direction to decrease the final loss.

### CROSS-REFERENCE TO RELATED APPLICATIONS

This application claims the benefit under 35 USC § 119(a) of Korean Patent Application No. 10-2022-0147117, filed on Nov. 7, 2022, in the Korean Intellectual Property Office, the entire disclosure of which is incorporated herein by reference for all purposes.

### BACKGROUND

### 1. Field

The following description relates to a method and apparatus with training of a batch norm parameter.

### 2. Description of Related Art

A convolutional neural network (CNN) is a network that is applied to a wide range of computer vision applications, as non-limiting examples, such as image classification, denoising, image segmentation, and object detection.

Edge platforms and devices such as mobile phones and Internet of the things (IoT) have used deep neural network applications, including applications that incorporate lighter vision-specific models, such as, by way of non-limiting example, MobileNet (hereinafter, referred to as MobileNet).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor implemented method is provided. The method includes calculating a quantization error for each channel of a neural network using activation data output from a first layer of the neural network and a quantization scale of a second layer connected to the first layer, calculating a final loss using a regularization loss term determined based on the quantization error for each channel, and updating a batch norm parameter of the first layer in a direction to decrease the final loss.

The calculating of the quantization error for each channel may include quantifying, for each of the channels, the quantization error as an inverse of a signal-to-quantization-noise ratio (SQNR) for a corresponding scale.

The calculating of the final loss may include calculating the regularization loss by calculating an average of the quantization error for each channel.

The calculating of the final loss may include calculating the final loss by summing the regularization loss and a cross-entropy loss.

The updating of the batch norm parameter may include deriving the batch norm parameter in a direction reduces a value of the regularization loss by performing stochastic gradient descent using the final loss.

The updating of the batch norm parameter may include fixing values of all parameters of the neural network other than the batch norm parameter when updating the batch norm parameter.

The updating of the batch norm parameter may include training a quantization scale of the first layer to reduce the final loss.

The updating of the batch norm parameter may include measuring performance of the neural network having the updated batch norm parameter.

The method may further include calculating the regularization loss term according to

$${L}_{reg}^{l} = \frac{1}{\vert c \vert} {\sum }_{j ∈ C} 1 / S Q N R ( {f}_{l}^{j} , {α}^{l + 1} ) ,$$

$$S Q N R ( X , α ) = \frac{E [ {X}^{2} ]}{E [ X - Q ( X , α ) ]}$$

wherein L_{reg}^{l} denotes the regularization loss, SQNR denotes a signal-to-quantization-noise ratio (SQNR), C denotes a channel, f and X denote the activation data, l denotes a layer, and a denotes a quantization scale.

A non-transitory computer-readable storage may store instructions that when executed by a processor, cause the processor to perform the method above.

In one general aspect, an apparatus is provided. The apparatus includes one or more processors configured to execute instructions, and a memory the storing instructions, wherein execution of the instructions by the one or more processors configure the one or more processors to calculate a quantization error for each channel of a neural network using activation data output from a first layer of the neural network and a quantization scale of a second layer connected to the first layer, calculate a final loss using a regularization loss term based on the quantization error for each channel, and update a batch norm parameter of the first layer in a direction to decrease the final loss.

The one or more processors may be configured to, when calculating the quantization error for each channel, quantify, for each of the channels, the quantization error as an inverse of a signal-to-quantization-noise ratio (SQNR) for a corresponding scale.

The one or more processors may be configured to, when calculating the final loss function, calculate the regularization loss by calculating an average of the quantization error for each channel.

The one or more processors may be configured to, when calculating the final loss, calculate the final loss by summing the regularization loss and a cross-entropy loss.

The one or more processors may be configured to, when updating the batch norm parameter, derive the batch norm parameter in a direction reduces a value of the regularization loss by performing stochastic gradient descent using the final loss.

The one or more processors may be configured to, when updating the batch norm parameter, fix values of all parameters of the neural network other than the batch norm parameter.

The one or more processors may be configured to, when updating the batch norm parameter, train a quantization scale of the first layer to reduce the final loss.

The one or more processors may be configured to, when updating the batch norm parameter, measure performance of the neural network having the updated batch norm parameter.

The one or more processors may be configured to calculate the regularization loss by applying

$${L}_{reg}^{l} = \frac{1}{\vert c \vert} {\sum }_{j ∈ C} 1 / S Q N R ( {f}_{l}^{j} , {α}^{l + 1} ) ,$$

$$S Q N R ( X , α ) = \frac{E [ {X}^{2} ]}{E [ X - Q ( X , α ) ]}$$

and wherein L_{reg}^{l} denotes the regularization loss, SQNR denotes a signal-to-quantization-noise ratio (SQNR), C denotes a channel, f and X denote the activation data, l denotes a layer, and a denotes a quantization scale.

Other features and aspects will be apparent from the following detailed description, the drawings, and the claims.

### BRIEF DESCRIPTION OF THE DRAWINGS

FIGS. 1A and 1B illustrate examples of diversity according to a convolutional structure and a channel size respectively including a single convolutional layer and a simplified neural network with plural convolutional layers based on the single convolutional layer, in accordance with one or more example embodiments.

FIG. 2 illustrates an example of a method of training a batch norm parameter for a neural network, in accordance with one or more example embodiments.

FIG. 3 illustrates an example of a method of regularizing a batch norm parameter, in accordance with one or more example embodiments.

FIG. 4 illustrates an example of distribution of activation data for each channel by training a batch norm parameter, in accordance with one or more example embodiments.

FIG. 5 illustrates an example of a an electronic apparatus with training of a batch norm parameter for a neural network, in accordance with one or more example embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

One or more non-limiting examples may relate to a method of training quantization recognition in a neural network with a simplified structure.

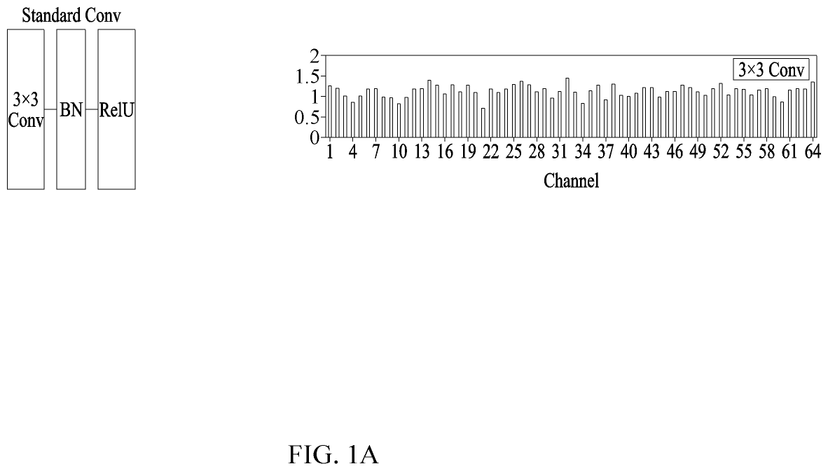

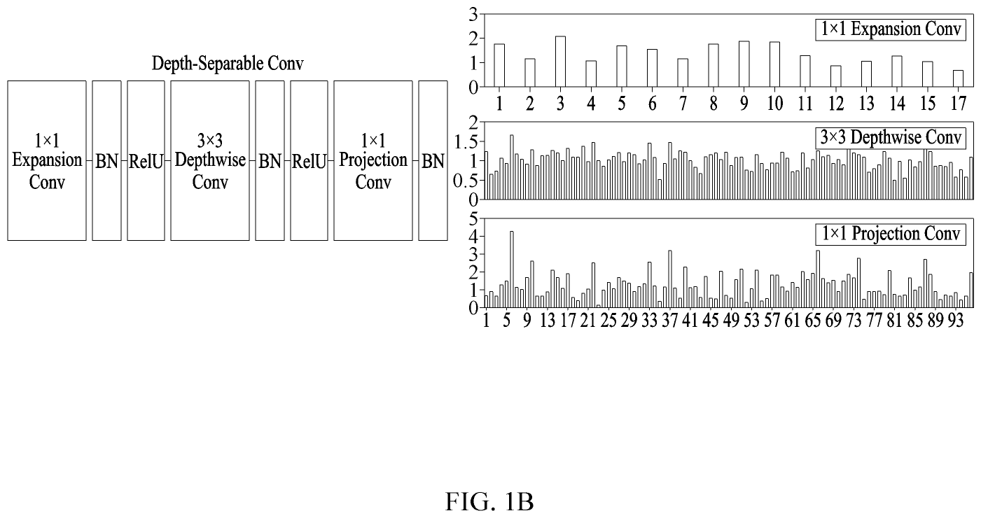

FIGS. 1A and 1B illustrate examples of diversity according to a convolutional structure and a channel size respectively including a single convolutional layer and a simplified neural network with plural convolutional layers based on the single convolutional layer, in accordance with example embodiments.

FIG. 1A may correspond to a basic convolutional layer, e.g., of a larger machine learning model, while FIG. 1B may correspond to multiple simpler convolutional layers in a depth direction. The separated convolutional structure of FIG. 1B may include a structure in which a first 1×1 convolutional channel layer, a second 3×3 convolutional channel layer, and a third 1×1 convolutional channel layer are connected, e.g., such that an output of the third layer generates an activation output corresponding to the activation output of the convolutional layer of FIG. 1A. Below, while examples will be described with respect to a neural network structure, this is merely for convenience of explanation, and examples exist where the below descriptions apply to other machine learning models.

As shown in FIG. 1B, a model with this convolutional network structure may be formed to provide efficient distributions of models to parameters such as, by way of non-limiting example, performed in a typical MobileNet approach. Compared to the single convolutional layer of FIG. 1A, the multiple convolutional layer structure of FIG. 1B may provide a lighter or lightweight structure, referred to herein as a simplified neural network, e.g., with simpler or less computational required operations than the layer of FIG. 1A.

The simplified neural network may be generated by decomposing convolutional calculations of a single layer, for example, cumulatively across channels and kernels in the generation of the multiple layers for the simplified neural network. Even though more layers exist, the generated simplified neural network of FIG. 1B may have a significantly smaller number of parameters and calculations compared to the single convolutional layer of FIG. 1A.

When a diversity of each channel is compared with respect to FIGS. 1A and 1B, the diversity of each channel of FIG. 1B may be larger than that of the basic 3×3 convolution of FIG. 1A. This may lead to performance degradation when low-bit quantization recognition training is performed to generate the simplified neural network.

Because such a simplified neural network structure may have a dynamic range of activation that varies for each channel, when a diversity of data distribution is large, a significant quantization error may occur in a single quantization scale.

In one or more embodiments, an initial simplified neural network structure (e.g., alike FIG. 1B) may be generated, e.g., from a lesser number of convolutional layers than in the generated simplified neural network, and a regularization may be performed to reduce the size of diversity for each channel, of the initial simplified neural network, with respect to the activation distribution through quantization recognition training. In an example, the simplified neural network may be generated from one or more recognition trained convolutional layers. The regularization may include training of a batch norm parameter as described herein below.

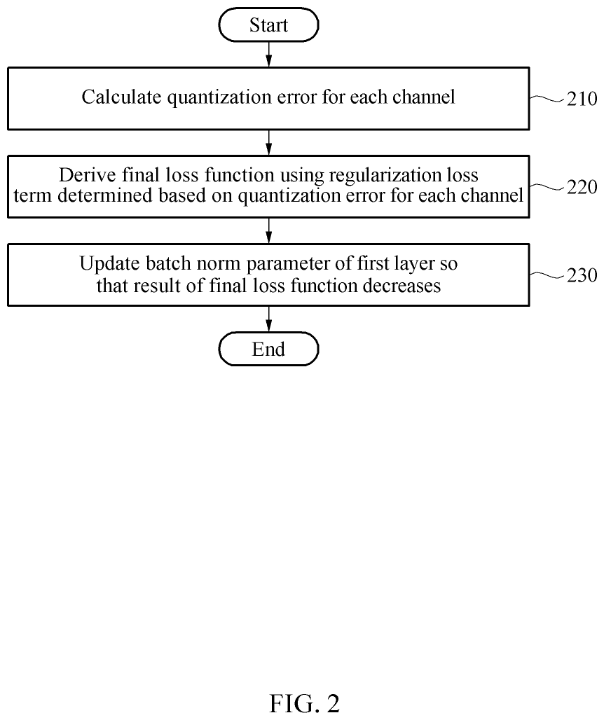

FIG. 2 illustrates an example of a method of training a batch norm parameter for a neural network according to one or more example embodiments.

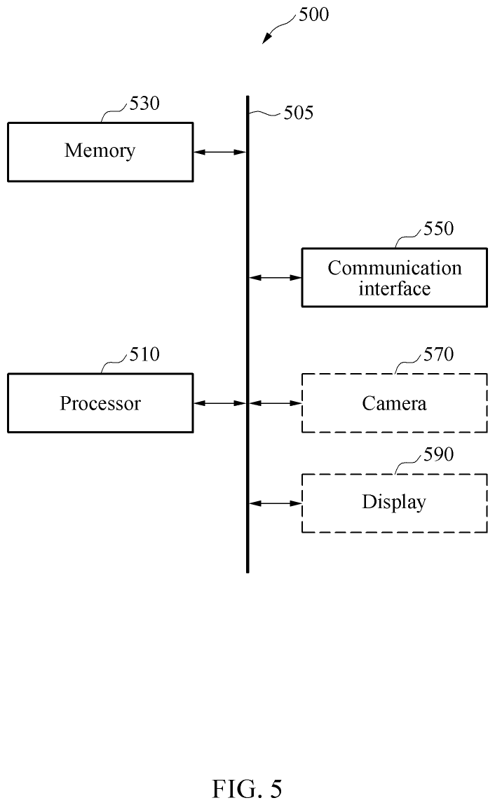

In operation 210, a computing device, for example one or more processors and/or the electronic device 500 of FIG. 5, may calculate the quantization error for each channel using activation data output from a first layer included in the neural network and a quantization scale of a second layer connected to the first layer. In an example, the neural network may be the simplified generated neural network of FIG. 1B. For example, prior to or in operation 210, the simplified neural network may be generated, such as by the aforementioned MobileNet approach.

In an example, a quantization result for a corresponding layer may be used to calculate an error of a quantization scale of a layer. The computing device may train a batch norm parameter to improve performance of the quantization that uses a single quantization scale for each layer, e.g., in the ultimate modified simplified neural network.

In an example, the computing device may quantify the quantization error using a signal-to-quantization-noise ratio (SQNR) for the single quantization scale of a corresponding layer for each channel. For example, the higher the SQNR, the greater the efficiency of quantization, or ultimate accuracy after quantization, so the quantization error may be quantified using an inverse of the SQNR.

The SQNR may be calculated based on a difference between activation data and a quantized value according to the quantization scale, and the smaller the difference between the quantized value and the activation data value, the larger the calculated SQNR. That is, the higher the quantization efficiency, the higher the SQNR.

In an example, the computing device may calculate the quantization error for each channel based on a quantization result.

In operation 220, the computing device may derive a final loss using a regularization loss determined based on the quantization error for each channel.

In an example, the computing device may calculate the regularization loss using a term for the SQNR that calculates the quantization error calculated above.

For example, the calculation of the regularization loss may include a calculation of a mean square error (MSE) for each channel of activation data before quantization and activation data after quantization, or variance of an average value for each channel of the activation data.

A size diversity for each channel may be reduced by calculating the regularization loss using the SQNR.

In an example, the computing device may calculate final loss by summing the regularization loss and a cross-entropy loss. Here, values of all parameters other than the batch norm parameter may be fixed. For example, the generated parameters of the initial simplified neural network, e.g., of FIG. 1B, may not be adjusted at this time, and only a batch norm parameter may be adjusted through training.

For example, in operation 230, the computing device may update a batch norm parameter of the first layer so that a result of the final loss decreases.

In an example, to train the batch norm parameter of the first layer, values of all parameters other than the batch norm parameter may be fixed.

An adjusted (or adjustment of a) batch norm parameter that reduces a value of the regularization loss may be determined by a stochastic gradient descent process using the calculated final loss. For example, a negative gradient may be calculated from the final loss, and the batch norm parameter may be adjusted based on the calculated gradient. In an example, a batch norm parameter may be regularized through quantization recognition training using the regularization loss input based on the quantization error for a feature map output after inputting the calculated regularization loss to the first layer.

In an example, the quantization scale may be simultaneously trained in addition to the batch norm parameter of the first layer, e.g., with all remaining parameters being fixed, so that the result of the final loss decreases based on the quantization error for the feature map output after inputting the calculated regularization loss to the first layer. A single quantization scale for each layer of the first layer may be used for the quantization scale.

In an example, task performance of the neural network by the batch norm parameter may be measured. To this end, examples may identify or define a diversity for each channel for measuring the task performance of the neural network.

In an example, the regularization loss may be calculated based on the batch norm parameter, in particular, the SQNR for a scale corresponding to each activation channel. When updating the scale with loss, the quantization error for each channel may be minimized in the training by adjusting a dynamic range of activation data.

In an example, for the quantization recognition training, a weight parameter may be adjusted by applying low-precision quantization in a training process of a neural network model. In an example, the quantization may be defined by Equation 1 below.

$$Q ( X , α ) = ⌈ ( Clamp ( X , α ) \cdot \frac{{2}^{k} - 1}{α} ⌋ \cdot \frac{α}{{2}^{k} - 1} = {X}_{I} \cdot c ( α ) \qquad Equation 1$$

Here, k may denote a bit width, Xₗ may denote an integer representation of a tensor X, α may denote a scalar that determines a quantization scale, and c(α) may denote a corresponding coefficient. The quantization for each channel may use a matrix multiplication with an integer in which the precision is reduced. Equation 1 may be calculated by the matrix multiplication with the integer in which the precision is reduced and scalar multiplication.

The quantization scale a determines the quantization error in a situation in which a target bit width k is given, therefore to reduce the quantization error it may be desirable to identify an appropriate quantization scale for the quantization recognition training. Examples may parameterize the quantization scale. Since quantization parameter values are adjusted according to data characteristics, the quantization accuracy may be improved.

In an example where the MobileNet approach is performed to generate the initial simplified neural network as demonstrated in FIG. 1B, e.g., such a convolutional layer may be cumulatively decomposed to convolutional calculations across channels and weight layers. For example, when a 3×3 convolutional layer of FIG. 1A is decomposed, the 3×3 convolutional layer may be decomposed into a 3×3 layer and 1×1 convolutional layers before and after the decomposed 3×3 convolutional layer. This method may reduce the overall number of parameters, e.g., compared to the convolutional layer of FIG. 1A, while the number of activations may not decrease. Due to the characteristics of this example simplified neural network with depth wise separable convolutions, the diversity has large data, so the batch norm parameter may be applied to calculate the decomposed convolution.

In an example, the batch norm parameter may be defined as in Equation 2.

$$BN ( {X}_{ch} ) = {γ}_{ch} {\hat{X}}_{ch} + {β}_{ch} = {γ}_{ch} \frac{{X}_{ch} - {μ}_{ch}}{{σ}_{ch}} + {β}_{ch} \qquad Equation 2$$

Here, γch and βch may denote batch norm parameters, and when a standard deviation σch of a channel is close to “0”, normalized activation \hat{X}_{ch} may diverge.

In an example, instead of changing the simplified neural network, e.g., of FIG. 1B, by depth to regularize the activation distribution, the SQNR-based regularization of the batch norm parameter may be applied. Such regularization may improve the accuracy in models for low-bit quantization.

The activation distribution may have a significant size diversity for each channel due to structural characteristics such as a separated convolution by depth of the simplified neural network. Since the diversity of the channel size causes the quantization error and lowers the accuracy of a quantized network, a regularized activation distribution that reduces the size diversity for each channel may be proposed for more accurate quantization recognition training for the simplified neural network with the depth wise separate convolutions. The method described below may regularize the batch norm parameter based on the SQNR of the activation. The proposed SQNR-based batch norm regularization (SBR) method may adjust the activation distribution in a direction of reducing the quantization error supported by empirical observation.

An example idea of the activation regularization may be that the batch norm parameter γ determines the magnitude of each channel of the activation. In an existing setting, the batch norm parameter may be optimized during training with an appropriate scale, but distributions may not match when applying the quantization. Thus, the batch norm parameter γ may be regularized to explicitly reduce the quantization error. Here, the quantization error may be quantified using the SQNR.

$$S Q N R ( X , α ) = \frac{E [ {X}^{2} ]}{E [ X - Q ( X , α ) ]} \qquad Equation 3$$

According to Equation 3, the SQNR may be quantified so that a difference before and after the quantization is reduced.

The regularization loss may be calculated according to Equation 4

$${L}_{reg}^{l} = \frac{1}{\vert c \vert} {\sum }_{j ∈ C} 1 / S Q N R ( {f}_{l}^{j} , {α}^{l + 1} ) ,$$

where L_{reg}^{l} denotes the regularization loss, SQNR denotes a signal-to-quantization-noise ratio (SQNR), C denotes a channel, f and X denote the activation data, l denotes a layer, and α denotes a quantization scale.

To suppress the quantization error, a loss term for L_{SBR}^{l} may be defined as an average of an inverse of the SQNR.

$${L}_{SBR}^{l} = \frac{1}{\vert C \vert} {\sum }_{j ∈ C} \frac{1}{S Q N R ( ReLU ( BN ( Q ( {X}^{l} ) ) ) , {α}^{l + 1} )} \qquad Equation 5$$

Equation 5 may represent a loss of a batch norm parameter corresponding to a channel. Here, C may denote a set of channels. L_{SBR}^{l} may be calculated as 0 when the quantization error is 0 (i.e., Q (X, α)=X), otherwise a loss may occur. To explicitly regularize the batch norm parameter, the other parameters from the graph may be separated so that a gradient for L_{SBR}^{l} may be generated only for the batch norm parameter. The total loss of the quantization recognition training may be expressed as follows.

$$L = {L}_{CE} + λ \cdot \frac{1}{L} {\sum }_{l ∈ \vert L \vert} {L}_{SBR}^{l} \qquad Equation 6$$

Here, λ is a coefficient of L_{SBR} for a balance with a cross-entropy loss (LCE). The method of regularizing the batch norm may adjust the activation distribution in a direction of maximizing the SQNR by regularizing the batch norm parameter.

In an example, the total loss of the quantization recognition training may be expressed as a sum of the LCE and the quantization loss for each channel. In particular, the quantization error for each channel may be statistically processed and used as an average value.

In an example, when training the batch norm parameter, a change amount of the regularization loss term may be calculated, and a direction of updating the batch norm parameter may be determined based on the stochastic gradient descent according to whether the calculated value is negative or positive. The regularization loss term may update the batch norm parameter so that a dynamic range of the activation data matches the quantization scale for each channel.

In an example, a diversity for each channel may be defined to quantify the effect of the regularization method on the quantization recognition training.

$${CD}^{l} ( X ) = \frac{1}{\vert C \vert} {\sum }_{j ∈ C} \frac{\vert R ( {X}_{j}^{l} ) - 𝔼 [ R ( {X}_{j}^{l} ) ] \vert}{𝔼 [ R ( {X}_{j}^{l} ) ]} \qquad Equation 7$$

Here, R(Xⱼ) may denote a dynamic range of a j-th channel of X. l may denote an index of a layer, and C may denote a channel.

CD may denote a relative deviation of the dynamic range of the channel from an average. A value of the relative deviation CD may be designed to be reduced by adjusting a magnitude of the activation data of the channel through normalization of the batch norm parameter.

Through the method of the example, a channel diversity of all layers may be reduced. A significant reduction in a channel diversity may be achieved for a layer showing the greatest difference in the dynamic range. This may lead to reduction of the quantization error and may be applied to the quantization recognition training of ultra-low-bit neural network models. For example, through this process, a final simplified neural network structure may be generated through quantization to have the ultra-law-bit structure.

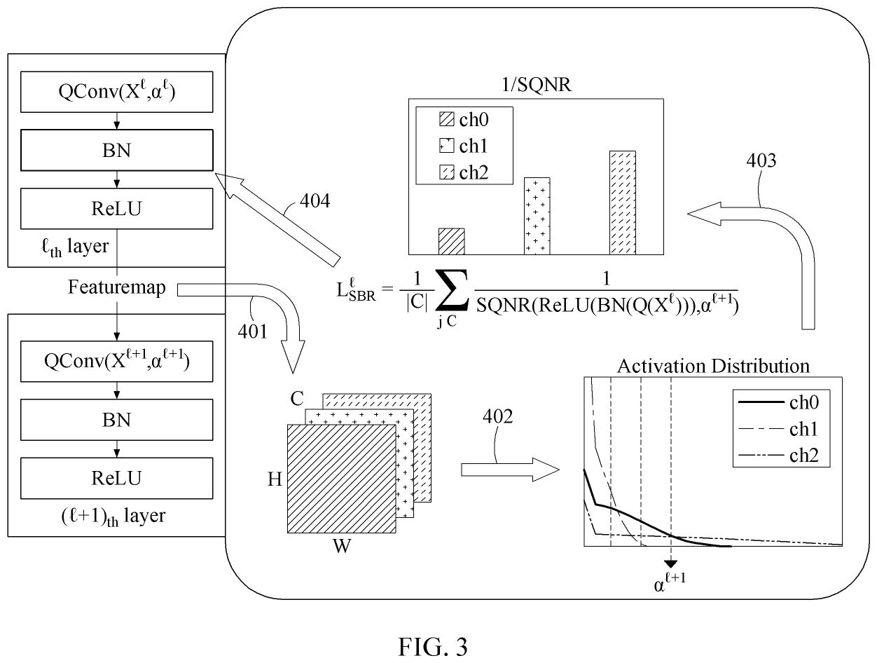

FIG. 3 illustrates an example of a method of regularizing a batch norm parameter according to one or more example embodiments.

A neural network may include at least two layers and may have a convolutional structure including a convolution, a batch norm, and a rectified linear unit (ReLU) layer for each layer.

In operation 301, activation data output from a layer of the convolution may be considered. For example, characteristics of a feature map output from a layer may be considered.

In operation 302, a diversity for each channel may be observed or determined. Tensors of the feature map may be quantized using a single quantization scale for each channel that is predetermined (which may be trained later), and the diversity may be calculated based on a quantization result.

In operation 303, a regularization loss may be calculated for each quantized channel. As described above, the regularization loss may be calculated through statistical processing such as an average using an inverse of the SQNR. Here, a quantization scale of a next layer connected to a corresponding layer may be used on the quantization scale for determining the regularization loss.

In operation 304, the regularization loss may be reflected in the final loss for updating the batch norm parameter. The update may be based on the stochastic gradient descent.

In an example, a dynamic range of the activation data may be adjusted based on the updated batch norm parameter and the quantization error may be reduced when the dynamic range is adjusted.

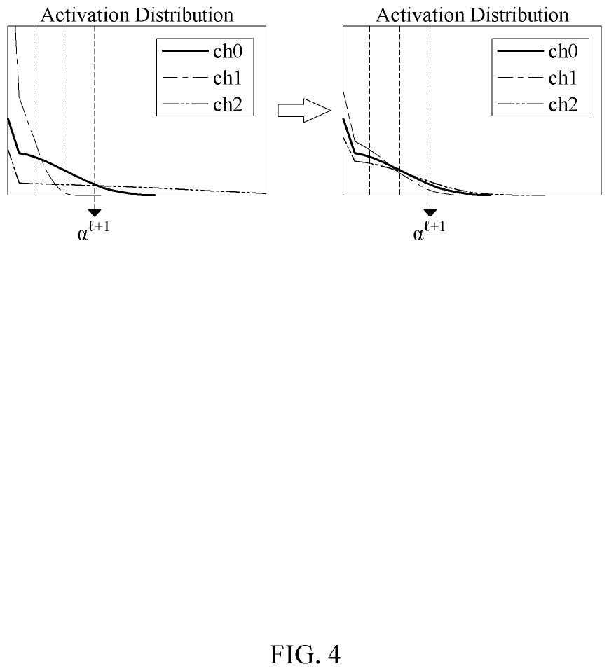

FIG. 4 illustrates an example of distribution of activation data for each channel by training a batch norm parameter according to one or more example embodiments.

In an example, by training the batch norm parameter, the diversity of the size of each channel for the activation data distribution may be reduced compared to the initial simplified neural network structure, e.g., of FIG. 1B, so that the distribution of the activation data may be adjusted to be suitable for a single quantization scale.

Since activation data of channel 1 (ch1) has a small dynamic range, the batch norm parameter may be increased to expand the dynamic range, when a quantization scale is given. On the other hand, since the activation data of channel 2 (ch2) has a wider range than the quantization scale, the batch norm parameter may be reduced, and thus, the dynamic range may be reduced.

Such methods of adjusting the dynamic range of the activation data may reduce the quantization error.

FIG. 5 illustrates an example electronic device that performs training of a batch norm parameter of a machine learning model according to one or more example embodiments.

Referring to FIG. 5, an electronic device 500 may be configured to perform operations of a method of generating a simplified neural network structure, and training a batch norm parameter for generating a final simplified neural network structure with the learned batch norm parameter. The electronic device 500 may include a processor 510 (i.e., one or more processors), a memory 530 (i.e., one or more memories), and a communication interface 550. The processor 510, the memory 530, and the communication interface 550 may communicate with each other via a communication bus 505. In an example, the electronic device further includes camera 570 and/or display 590.

The processor 510 may perform a method of training a batch norm parameter for a neural network. In an example, the processor 510 may be configured to generate an initial simplified neural network structure for convolutional layer(s) of a trained recognition neural network.

Accordingly, the electronic device 500 may generate the initial simplified neural network structure and train the batch norm parameter and obtain a result, e.g., by the processor 510 or through execution of instructions stored in the memory 530 by the processor 510, to configure the processor 510 to perform any one or combination of operations or methods described herein.

The processor 510 may include calculating a quantization error for each channel using activation data output from a first layer included in a neural network and a quantization scale of a second layer connected to the first layer, deriving a final loss function using a regularization loss term determined based on the quantization error for each channel, and updating a batch norm parameter of the first layer so that a result of the final loss function decreases. The processor 510 may further generate an updated recognition neural network by replacing a corresponding convolutional layer of the recognition neural network with the simplified neural network structure updated according to the learned batch norm parameter. The processor 510 may perform a recognition operation using the updated recognition neural network.

The memory 530 may be a volatile memory or a non-volatile memory, and the processor 510 may execute a program and control the electronic device 500. Code of the program executed by the processor 510 may be stored in the memory 530. The electronic device 500 may be connected to an external device (e.g., a personal computer (PC) or a network) through an input/output device to exchange data therewith. The electronic device 500 may be various computing devices and/or systems such as a smartphone, a tablet computer, a laptop computer, a desktop computer, a television (TV), a wearable device, a security system, a smart home system, and the like.

The computing devices, electronic devices, processors, memories, cameras, displays, communication interfaces, and buses described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

The example embodiments reduce diversity of activation data and thereby improve quantization and performance of neural networks such as a simplified structure neural network with depth wise separable convolutions in which a diversity of activation data is large.

The example embodiments may provide an efficient CNN structure for edge devices that efficiently utilizes limited computing resources and power budgets.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
calculating a quantization error for each channel of a neural network using activation data output from a first layer of the neural network and a quantization scale of a second layer connected to the first layer;
calculating a final loss using a regularization loss determined based on the quantization error for each channel; and
updating a batch norm parameter of the first layer in a direction to decrease the final loss.

2. The method of claim 1, wherein the calculating of the quantization error for each channel further comprises quantifying, for each of the channels, the quantization error as an inverse of a signal-to-quantization-noise ratio (SQNR) for a corresponding scale.

3. The method of claim 1, wherein the calculating of the final loss comprises calculating the regularization loss by calculating an average of the quantization error for each channel.

4. The method of claim 1, wherein the calculating of the final loss comprises calculating the final loss by summing the regularization loss and a cross-entropy loss.

5. The method of claim 1, wherein the updating of the batch norm parameter comprises deriving the batch norm parameter in a direction reduces a value of the regularization loss by performing stochastic gradient descent using the final loss.

6. The method of claim 1, wherein the updating of the batch norm parameter comprises fixing values of all parameters of the neural network other than the batch norm parameter when updating the batch norm parameter.

7. The method of claim 1, wherein the updating of the batch norm parameter comprises training a quantization scale of the first layer to reduce the final loss.

8. The method of claim 1, wherein the updating of the batch norm parameter comprises measuring performance of the neural network having the updated batch norm parameter.

9. The method of claim 1, further comprising:
calculating the regularization loss—according to:
$${L}_{reg}^{l} = \frac{1}{\vert c \vert} {\sum }_{j ∈ C} 1 / S Q N R ( {f}_{l}^{j} , {α}^{l + 1} ) ,$$
$$S Q N R ( X , α ) = \frac{E [ {X}^{2} ]}{E [ X - Q ( X , α ) ]}$$
wherein L_{reg}^{l} denotes the regularization loss, SQNR denotes a signal-to-quantization-noise ratio (SQNR), C denotes a channel, f and X denote the activation data, l denotes a layer, and a denotes a quantization scale.

10. A non-transitory computer-readable storage medium storing instructions that, when executed by a processor, cause the processor to perform the method of claim 1.

11. An apparatus, the apparatus comprising:
one or more processors configured to execute instructions; and
a memory storing the instructions, wherein execution of the instructions by the one or more processors configure the one or more processors to:
calculate a quantization error for each channel of a neural network using activation data output from a first layer of the neural network and a quantization scale of a second layer connected to the first layer;
calculate a final loss using a regularization loss term based on the quantization error for each channel; and
update a batch norm parameter of the first layer in a direction to decrease the final loss.

12. The apparatus of claim 11, wherein the one or more processors are configured to, when calculating the quantization error for each channel, quantify, for each of the channels, the quantization error as an inverse of a signal-to-quantization-noise ratio (SQNR) for a corresponding scale.

13. The apparatus of claim 11, wherein the one or more processors are configured to, when calculating the final loss, calculate the regularization loss by calculating an average of the quantization error for each channel.

14. The apparatus of claim 11, wherein the one or more processors are configured to, when calculating the final loss, calculate the final loss by summing the regularization loss and a cross-entropy loss.

15. The apparatus of claim 11, wherein the one or more processors are configured to, when updating the batch norm parameter, derive the batch norm parameter in a direction that reduces a value of the regularization loss by performing stochastic gradient descent using the final loss.

16. The apparatus of claim 11, wherein the one or more processors are configured to, when updating the batch norm parameter, fix values of all parameters of the neural network other than the batch norm parameter.

17. The apparatus of claim 11, wherein the one or more processors are configured to, when updating the batch norm parameter, train a quantization scale of the first layer to reduce the final loss.

18. The apparatus of claim 11, wherein the one or more processors are configured to, when updating the batch norm parameter, measure performance of the neural network having the updated batch norm parameter.

19. The apparatus of claim 11, wherein the one or more processors are configured to calculate the regularization loss according to
$${L}_{reg}^{l} = \frac{1}{\vert c \vert} {\sum }_{j ∈ C} 1 / S Q N R ( {f}_{l}^{j} , {α}^{l + 1} ) ,$$
$$S Q N R ( X , α ) = \frac{E [ {X}^{2} ]}{E [ X - Q ( X , α ) ]}$$
wherein L_{reg}^{l} denotes the regularization loss, SQNR denotes a signal-to-quantization-noise ratio (SQNR), C denotes a channel, f and X denote the activation data, l denotes a layer, and α denotes a quantization scale.
